(19) United States
(12) Patent Application Publication
(10) Pub. No.: US 2011/0082782 A1
(43) Pub. Date: Apr. 7, 2011

(54) Relocation Calculator Object Oriented System and Method

(76) Inventors: Wendy Komac, Sandusky, OH (US); Robert W. Stecher, Annapolis, MD (US)

(21) Appl. No.: 12/575,240

(22) Filed: Oct. 7, 2009

(51) Int. Cl. G06Q 50/00; G06Q 40/00; G06F 17/30; G06F 15/16; G06F 17/00; G06F 3/048

(52) U.S. Cl. 705/35; 707/822; 709/219; 715/212; 715/764; 707/737; 707/E17.01; 707/E17.089; 707/754; 707/E17.059

(57) ABSTRACT

The present invention involves a computer or a server for providing a user a relocation cost calculation system. A a relocation data file includes information on relocation expenses, including calculated information based on historical data relating to house parameters and transaction parameters. An interface module is used to receive the house and transaction parameters on a relocation project from the user, and is capable of presenting a total cost of ownership report to the user. Calculator software creates the total cost of ownership report based on the house and transaction parameters received from the interface module and the relocation data file. The relocation data file is created by obtaining relocation expense data records that include historical expense data. The dimensions of the relocation expense database are specified for segmentation. The expense data records are classified according to the specified dimensions. The expense database is filtered according to user specified criteria. The data fields are calculated from the filtered expense database according to the specified dimensions among the specified segments.

### BACKGROUND OF THE INVENTION

1. Field of the Invention

The invention relates to relocation management software.

2. Description of the Related Art.

In 2008, it is estimated that $24 Billion was spent in the U.S. on corporate relocation, that is the transfer of employees from one location to another which requires the employee to move residences. Those corporations, on average, spent about $16.3 million. The relocated employees may have been new hires (⅓) or current employees (⅔), with 45% being homeowners and the remainder renters. The costs of these relocations vary by family size, homeowner status, and the terms the employer offers.

Transferees typically receive some type of miscellaneous allowance that they can spend as they see fit to take care of incidentals they will incur in the new location such as getting new vehicle registrations, utility hook-ups and carpet/drapery installations. This allowance is most often equal to one month of the employee's salary. Most companies offer to purchase at least some employees' homes if the employees' cannot sell the home on their own. To do this, most (about two-thirds) outsource the management of the homesale program. About 5 percent keep it in-house. Another 20 percent of organizations reimburse employees' selling expenses only—they don't offer to buy the employees' homes. About 1 in 10 doesn't provide any type of homesale assistance to employees. It is virtually impossible to arrive at other “average” costs on a global basis because of the wide disparity, for instance in the cost of schooling, housing, cost of living, cost of currency (for international relocations), etc. from one location to another. It is thus difficult to ascertain relocation costs.

### SUMMARY OF THE INVENTION

The present invention involves cost management software specifically relating to the relocation industry. Historical Home Sale data is analyzed and the average costs as a percentage of home value is calculated as a function of type of relocation product, and the home and market situation which is adjusted the length of relocation, also known as program days, where applicable. Relocation products are parsed into different levels (where homes are actually sold and where homes actually went into inventory). Data is selected for the filtered time period (in an exemplary embodiment a rolling year), Home Value ranges to throw out extreme outliers (extremely low and high cost homes), and Authorization status (using homes that closed or were reconciled within the time period). A factor derived from an overall analysis of the data is applied to account for the impact of program days. Since inventoried homes are significantly more expensive than non-inventoried homes, the analysis is done at the inventoried (RE) or non-inventoried (AM) level, and the results are combined using the program's overall amended value rate.

The Total Cost of Ownership Calculator (TCO-C) is a software tool intended to calculate the most probable overall program cost for a potential client's relocation services package and to compare those costs either to an overall estimate of industry average (ERC) costs for like-services, or, more effectively, to the client's existing or alternative program. The calculator software uses recent historical data as the basis for the comparisons. In order to better match a client's situation, the calculator software allows for controlling several of the major cost-driving “input variables” in the relocation industry in each of several major cost generating areas. These are: (1) Home Sale: Number of homes (one or two-tiered program), average home value (in each tier), product (AVO, BVO), and the delay “Policy” of guaranteed buyout offer (GBO) where applicable. The geographic areas of the relocation data are segmented on value and performance with Calculator results are correlated thereto; (2) Mortgage: The impact on client costs are shown for traditional and non-traditional mortgages; (3) Temporary Living: Impact of shortened Home Sale days on market, other variables; (4) House Hold Goods Transportation: typical costs are given for client based on the size of the house hold; and (5) Earnings Per Share (EPS) module that calculates, for a publicly traded company, the EPS impact (pennies per share) of the proposed relocation.

For most of the input variables the user has the ability to accept or override the given industry average (ERC) numbers (for client input) or company specific average numbers (for an individual company's offering). The historical data used in the analysis may be filtered to select the time period (e.g., most recent rolling one-year), home value range (e.g., $20,000-$3,000,000), and the status (e.g., Closed or Reconciled) homes. This allows the calculator software to maintain temporal relevance. For users with portable devices, the calculator software produces a calculated average cost database much smaller than the total available data so that the portable device may be used to estimate relocation costs. Such a portable device user should periodically replace the calculated average cost database periodically to avoid using outdated figures.

The present invention, in one form, relates to a computer for providing a user a relocation cost calculation system. The computer includes a relocation data file including information on relocation expenses, including calculated information based on historical data relating to house parameters and transaction parameters. An interface module receives the house and transaction parameters on a relocation project from the user, and is capable of presenting a total cost of ownership report to the user. Calculator software creates the total cost of ownership report based on the house and transaction parameters received from the interface module and the relocation data file.

The present invention, in another form, is a method of creating a relocation expense database. Relocation expense data records are obtained that include historical expense data. Dimensions of the relocation expense database are specified for segmentation. The expense data records are classified according to the specified dimensions. The expense database is filtered according to user specified criteria. Data fields are calculated from the filtered expense database according to the specified dimensions among the specified segments.

Further aspects of the present invention involve a server for providing remote users a relocation cost calculation system. The server includes a relocation database including information on relocation expenses, with calculated information based on historical data relating to house parameters and transaction parameters. A user interface module is capable of sending interaction software to remote users. The interaction module is adapted to request entry of house and transaction parameters for transmission to the server, and adapted to present a total cost of ownership report to the remote user. An interface module receives house and transaction parameters on a relocation project from instances of the interaction software, and is capable of creating a total cost of ownership report to the remote user via instances of the interaction software. Calculator software creates the total cost of ownership report based on the house and transaction parameters received from the interface module and the relocation database.

Another aspect of the invention relates to a machine-readable program storage device storing encoded instructions for a method of operating a computer by interfacing with a user to receive house and transaction parameters on a relocation project, calculating a total cost of ownership report based on the house and transaction parameters received from the user and a relocation data file, and presenting the total cost of ownership report to the user.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the user interaction and data flow in accordance with an embodiment of the present invention.

FIG. 2 is a flow chart diagram of the operation of an embodiment of the present invention relating to the creation of the relocation data base.

FIG. 3 is a screen shot showing the operation of an embodiment of the present invention relating to user interaction with the relocation cost calculator.

FIG. 4 is a flow chart diagram of the operation of an embodiment of the present invention relating to the calculation of relocation costs.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), and iPhone OS (iPhone is a registered trademark of Apple, Inc. of Cupertino, Calif.). “Mobile Apps” refers to software programs written for execution with Mobile Software.

In relation to the relocation industry, the following terms generally refer to the meanings described below unless the context specifies otherwise. The “relocator” is the individual, typically an employee of an organization, where the organization has directed the relocation. The “relocation agent” is the entity, typically a company specializing in the relocation of individuals or groups of individuals, which is contracted with by the organization that directed the relocation by the relocator. “Transferring Organization” refers to the organization that has directed the relocation of the individuals. “Industry” refers to a collection of entities that deal with the relocation of individuals or groups of individuals. “Program” refers to the type and parameters of a relocation transaction, for example the time allowed for the relocation agent to complete the relocation, and the time allowed for the relocator to sell the house before the house becomes the inventory of the relocation agent. “Market Type” refers to a category of a geographic region that has an associted classification. “Amended Value Option” or “AVO” refers to a relocation situation where the relocator sells his or her house rather than having the relocation agent purchase the house. “Buyer Value Option” or “BVO” refers to a relocation situation where the relocation agent purchases the house and then must sell the house as its own inventory.

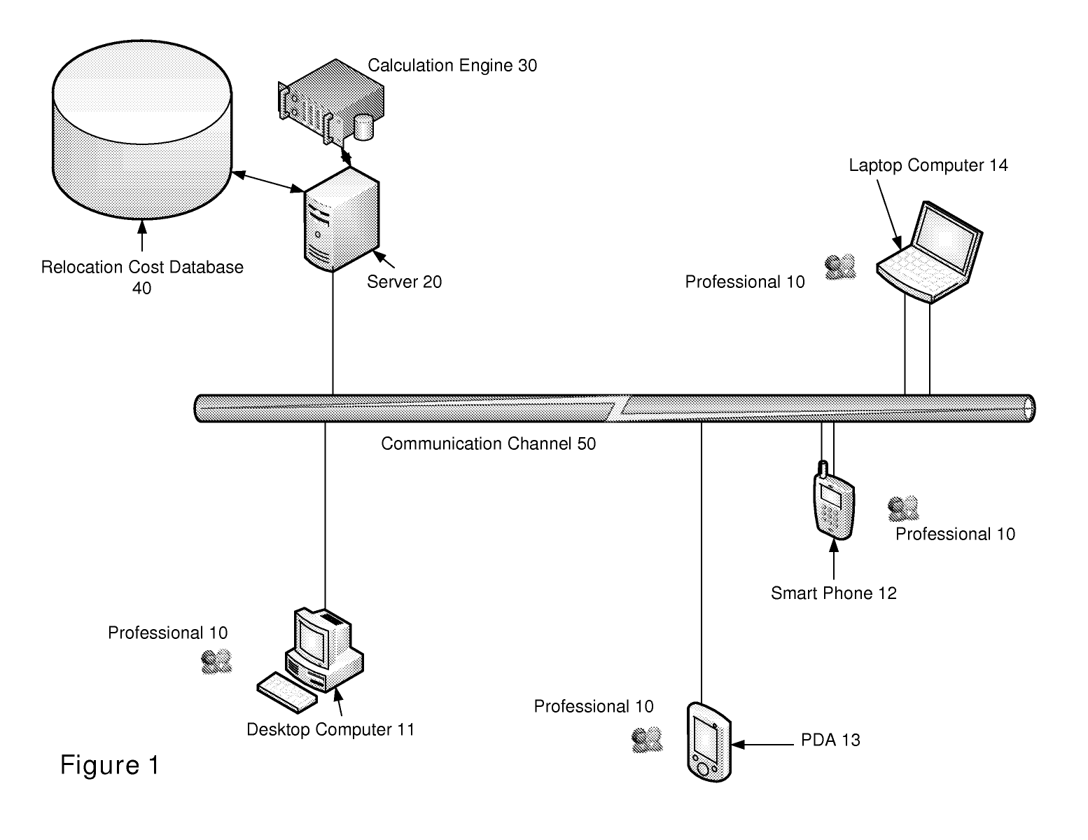

FIG. 1 generally represents an embodiment of the invention providing a remotely accessible interface of a relocation professional with a relocation cost estimator. Professional 10 may represent a human resource professional with a business organization, an outside relocation consultant, or a relocation company employee, utilizing desktop computer 11, smart phone 12, PDA 13, or laptop computer 14. Server 20 has calculation engine 30, also known as cost calculator software 30, having access to relocation cost databases 40, and having a communications channel 50 for obtaining and delivering information to and from professional 10. Communications channel 50 may be dynamic, such as a telecommunications connection with a computer (not shown) over a TCP/IP communications network, including but not limited to the Internet, or alternatively over a wireless connection via a mobile phone or a PDA. Alternatively, communications channel 50 may be static, such as a portable computer or PDA with pre-loaded software and data which may be periodically updated by connection to server 20.

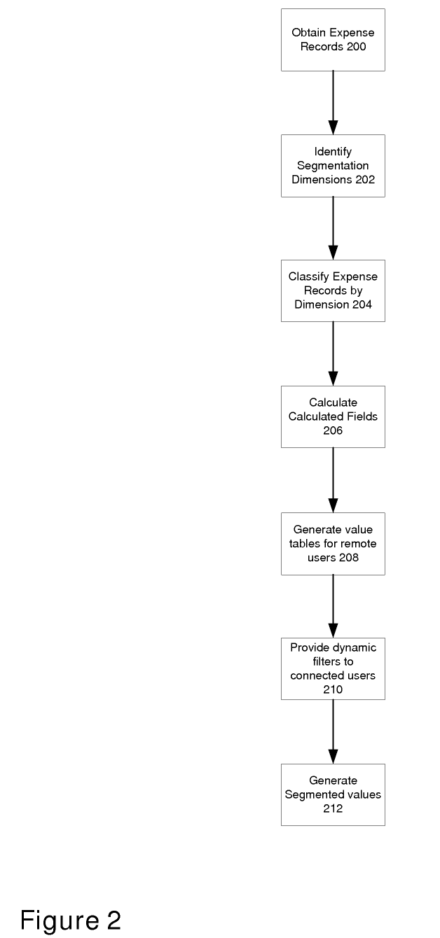

Relocation cost databases 40 are created by the process disclosed in FIG. 2, which provides one exemplary method to create databases which may be utilized in the context of the present invention. Thus, while one particular method is described below to obtain one particular embodiment of relocation cost databases, other suitable processes may be used in the alternative to create relocation cost databases 40. While the description below discusses separate relocation cost databases 40, such databases 40 may be implemented in a single database by use of suitable data storage techniques—but for simplicity of explanation the following shall refer to multiple logical databases regardless of the actual storage method.

The first step 200 is to obtain relocation expense data records that include historical expense data as well as other transaction data. In step 202, the dimensions (particular types of expense data for segmenting the general relocation expense data) are determined, e.g. Market Type and Program. Step 204 involves classifying the expense data records according to the dimensions determined in step 202. Calculated fields are next determined in step 206. For remote users, such as laptop computers or PDA's that are not connected to a network, step 208 provides for creating a full set of average expenses for all the categories in database 40 for all or a sub-set of the dimentional combinations possible. This allows for a detached device to use pre-filtered data previously calculated to obtain relevant expense estimates. Alternatively, step 210 provides available filters to connected users so that the most up-to-date data may be filtered and made available for segment averaging in step 212. As described below, although all expense averages may be calculated in step 212, the process according to the present invention allows for overriding particular values if in the judgement of professional 10 particular cost components may be more acurately determined from data other than the historical average data.

Data collected includes both expense data and descriptive data. Expense data, as detailed below, may be broken down into various levels of granularity as professional 10 sees fit. Descriptive data includes the house price, location, Program information, geographic market identification, etc. Some of the descriptive data may be boolean values or type values and may or may not be related to a particular expense. Other descriptive data may be used to segment the data so that a relevant subset of the entire relocation expense data is used for a particular relocation estimation.

Data is sorted and aggregated, in one embodiment, in pivot tables. Thus, expense data relating to a particular relocation program (e.g., dimension #1) in a particular Market Type (e.g., dimension #2) may be averaged for the purpose of estimating expenses. Thus, an expense data record is determined to belong to a particular Market Type, so that the particular instances of the data record are used to calculate average costs for that Market Type. In this embodiment, a single dimension is used to create the segmented data. However, alternative embodiments, as disclosured below, may have two or several dimensions across which expense data is segregated. The system according to the present invention provides a tool for professional 10 to operate on relevant data, with counts and averages presented as options along with the ability to override any particular expense item.

The data supplied to create the pivot tables may be further segregated by filters. Filters are a selection of data records that fulfill a predetermined criteria. One relevant filter is the time period filter. In relatively stable markets, the time filter may include a range of years, in contrast to a fastly changing market in which the time filter may be made in terms of months. For example, in the case of a expensive, fastly rising housing market, expense data from the last three months may have a better predictive value than data from the last three years. This would be in contrast to a modestly priced, stable housing market where expense data over the last three years may provide a better predictive value.

Additional calculated data fields are created by segregating and analyzing certain raw data. For example, the inventors of the present invention have determined that there are few data points for most individual locations for local housing factors, but that many of such individual locations have common characteristics that allow data to be combined. Thus, several types of local housing markets have been identified and each data set from a defined local housing market is assigned to one of the types so that more reliable statistics and parameters may be provided. For example, if the hypothetical city of Smithville has three examples of local housing expenses, statistics and parameters from those three examples would not necessarily have statistical relevance to predicting a fourth example's local housing expense. However, Smithville may be determined to be an expensive, fastly rising housing market type and there may be several hundred examples from similar expensive, fastly rising housing markets. Thusly, a proposed relocation involving Smithville may be calculated using statistically valid parameters based on a more numerous sample size.

As a further example, relocation cost databases 40 may include data records relating to specific aspects of relocation expenses: household goods moving, mortgages, broker costs, temporary living expenses, etc. Each of these general expenses may be broken down into further components so that virtually every expense is accounted for. The greater level of granularity involved, the less chance that an expense item will be omitted from the calculation. For example, direct home marketing costs includes at least four significant components: Closing Costs, Recurring Carrying Costs, Non-recurring Carrying Costs, and Gain/Loss on Sale. Each of these components may be broken down into further sub-catagories, and specific average or override values may be used in the calculation of the total relocation cost. Such information may be printed to paper or to an electronic file in a reporting format to illustrate the rolcation estimate assumptions.

Historical house sale data is analyzed and the average costs as a percentage of home value is calculated as a function of a particular Program and Market Type and adjusted for program days, where applicable. Programs may be parsed to the AVX-RE, AVX-AM, AVO-RE, AVO-AM, BX-RE, BVX-AM, BVO-RE, & BVO-AM level (where AM refers to those homes that actually sold amended and RE refers to those that actually went into inventory). Data may be selected for the filtered time period using a prorate date (for example, a rolling year ending May 31, 2009), home value ($20K <sell price <$3M) to throw out extreme outliers, and authorization status (authorization referring to houses that closed or were reconciled within the relevant time period). These selection values may be used to create static tables for remote users, and are easily adjustable through the filtering process for connected processing, both of which are available to professional 10.

A factor derived from an overall analysis of the data may be applied to the gain/loss percentage and the amended value percentage to account for the impact of program days (program days is an expression of a Program offering a guaranteed buy-out, where 90/120 means that if the house is not sold by the relocator in 90 days, the buy-out price will be the appraised house value at 90 days if the house is not sold in 120 days). These historical values may be displayed based on the selections made on the segmentation dimensions and used in the calculations of transfer costs. Since inventoried houses are significantly more expensive than non-inventoried houses, the analysis is done at the inventoried (RE) and non-inventoried (AM) level, and the results are combined using calculaion module 30's overall amended value rate.

Database 40 may be rather large, and possibly unsuitable for portable devices. Advantageously, a subset of database 40 containing the calculated averages across the segmented dimensions may be deployed to professional 10 so that a connection to server 20 is not necessary to provide estimates. The only lost functionality is the ability to change the filtering (e.g., date, value, status) parameters. The intent is that professional 10 using a static subset (not shown) of database 40 will periodically perform the refreshing of the static subset of database 40.

While industry average data may not be broken down into the specific segments that are possible when original data records are available, the resulting segmented averages may be used to create a normalization table so that the specific segmented known values may be used to calculate multipiers for the industry averages that are representative of the selected segments. Like the segmented average costs discussed above, such normalized industry average tables may be calculated dynamically on server 20, and saved for static deployment as discussed above.

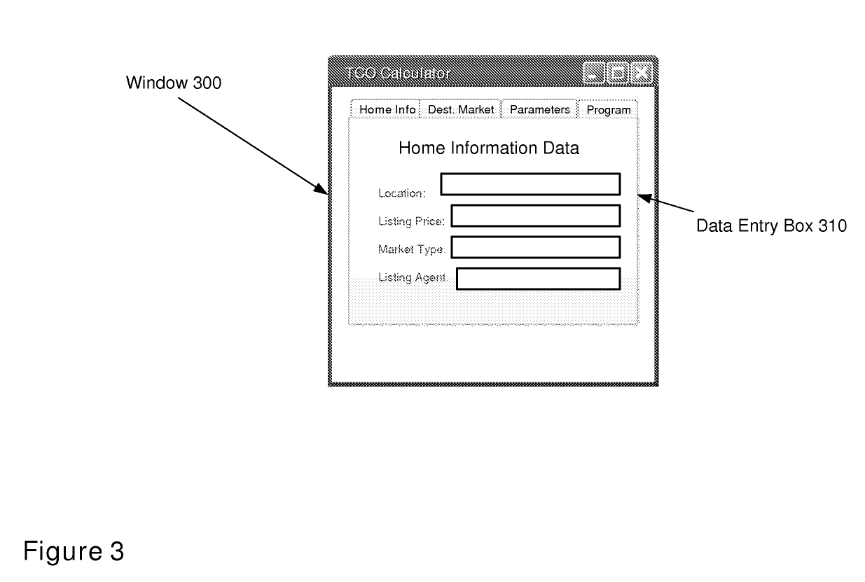

Professional 10 may interact with the relocation cost calculator software 30 as described in greater detail in connection with FIG. 3. Window 300 shows data entry box 310 having one or more tabs for the entry of detailed relocation information. Window 300, in one exemplary embodiment, is a client web page for entry of information for use by calculator 30. In another embodiment, window 300 may be one or more spreadsheet pages, graphic user interface data entry screens which connect to cells of the spreadsheet. In still another embodiment, window 300 may be a text based screen with multiple data entry lines for sending entered data over the network to the server. One or a series of data entry boxes may be created to obtain the information as set forth below. A variety of data entry tools, e.g., graphic character recognition entry, pull down menus, mouse driven scales, etc., may be used as alternative data entry mechanisms in window 300.

Initially, professional 10 may enter a home count (one for a single more, or more for a group move), home value (either by appraisal, listing price, or other method), and program type (for example, with a drop-down menu). At a point in data entry, professional 10 is shown various cost elements with associated industry or relocation agent averages for the house information entered and the total, and is provided an opportunity to adjust any cost element (or do nothing and accept default values). Advantageously, calculation software 40 allows professional 10 to override any expense value at various levels of detail. For example, values for a New Home mortgage, temporary living costs, and Household goods move costs may be overridden. In addition, professional 10 may alternatively select Direct Reimbursement or Employee Lump Sum programs instead of AVO or BVO, and select either a one or two tier program. With regard to a single relocation or a group relocation between two areas, professional 10 may also enter an Market Type selection (region or region behavior) for finer calculations of costs.

One exemplary scenario for professional 10 to use cost calculation module 30 involves picking a product type (AVX/BVX, etc) for each individual and tier (if applicable). A mortgage program type is selected for each, the fees are determined for each set of data. Professional 10 may compare the costs for each component to the Transferring Organication's program. Also, professional 10 may pick a program days option (e.g., 90/120), and split a one-tier program into two tiers or revise an existing split. A further option is to include or exclude various non home-sale costs, add a one-time implementation fee, and calculate the impact on the Transferring Organization's EPS.

Information relating to a house sale typically includes several components. Such information includes, for example, whether the situation is a one or a two-tiered program; the number of houses; average home value; Program type: AVO/BVO; if this situation is a direct reimbursement program; whether this situation is a Transferee Lump-Sum program; Policy Days (referring to the time allowed for the relocator to sell the house, e.g., 60/90); Market Type geographical/regional selection. Assuming that an AVO or BVO program type is selected, the relocation agent's average DHSC % (Direct Home Selling Cost, percent of home value) may be entered directly, alternatively the DHSC % may be calculated using historical data of the relocation industry, the historical data of the relocation agent, and/or estimates of professional 10. Blended DHSC is the weighted average home selling cost from homes that sold amended (that is, homes sold by the relocator rather than sold by the relocation agent) and those that sold through inventory. In turn, DHSC % is made up of real estate commissions, Loss/(Gain) on sale, and a potpourri of closing and carrying costs which may be lumped under a miscellaneous closing cost item, or alternatively further broken down into component items. Cost calculation software 30 allows professional 10 to compare relocation costs and percentages by overriding industry or relocation agent averages with a specific values so that situations involving more known quantities may be more accurately estimated.

Depending on what professional 10 knows about the relocator, the amount of overrides may be few or none, but in other cases many cost components are know with greater precision than the calculated averages. In the case of an amended house (sold directly by the relocator), both realtor costs and loss/gain on sale should be known, and their applicability to the cost calculation known by virtue of the type of Program involved. If the relocation is a group, and there are different tiers in the group (i.e., the services provided and associated costs are different for different groups) then cost calculator 30 allows professional 10 to separately evaluate each of the multiple tiers. In one emboidment, drop-down lists are used to select the relocator's existing program type (AVO, etc.), enter the number of houses, and the average house value (e.g., by selecting the range within which the actual value occurs). Drop down lists may also be provided for professional 10 to select the Market Type. If the Market Type is not on the drop-down list, or if the proposed relocation is spread over a broad range of areas, additional options are available. One option is to simply pick a market-trend descriptor (High, Medium, and Low home value in each of improving, stable, or declining market performance), another option is simply to use nationwide averages of industry or relocation agent data.

For AVO programs, a “Policy Day” selection is provided from, in one embodiment, a drop-down list (e.g., 60/90 or 100/150). Another option is to default to an industry or relocation agent average from historical data. Some Transferring Organizations, instead of an AVO/BVO program, directly reimburse relocators for house sale realtor's fees and other closing costs. Those Transferring Organizations may or may not also gross up the reimbursement for taxes to ‘make the relocator whole.’ That gross-up may be ‘one time’ (give the relocator the closing cost times their tax rate) or ‘full gross-up’ (since the gross-up is also taxable, give gross-up on the gross-up, ad infinitum, as may be calculated). In either event, professional 10 is provided with the option to substitute a direct reimbursement program for either AVO or BVO by cost calculator 30. Overrides for the realtor's fee and other closing costs as a percentage of home value may be added by professional 10. The relocator's incremental tax rate is input and the tax gross-up is calculated based on the selected gross-up policy for the Transferring Organization (e.g., none, one time, full).

A similar approach by some Transferring Organizations is to give the relocator a lump sum to cover all or some expenses. This lump sum may or may not be grossed-up for taxes. The lump sum approach may be used by itself or with an AVO/BVO, or direct reimbursement program.

Mortgage information for the new house is calculated, focusing on the potential tax gross-up savings available through the relocation agent's financing options, as opposed to using a local financing provider. Input variables include the average “step-up” in home value expected, the percentage of home value that is mortgaged, the number of points allowed for reimbursement by the Transferring Organization, and the relocator's incremental tax bracket

Another relavent data point is the costs associated with temporary living. This section may be calculated from industry or relocation agent historical infomation, is broken into the average daily cost (for the relocation agent and the Transferring Organization) and their average days on temporary living. The difference in (days)×(cost/day) represent potential savings.

Another relavent data point is the cost for moving the Household Goods. Typically, simply by entering distance of the relocation and weight of the relocator's possessions such moving costs may be calculated. However, it is possible to alter the discounts available relating to industry tariffs, and the cost of storage if needed may be added.

House sale costs may be displayed and summarized for each option/tier/Program. For AVX/BVX many costs are listed as “N/A” or “Included” since they are included in the fee structure and thus do not exist in this context. For AVO and BVO programs where the relocator pays actual home sale costs plus a fee, the summary home sale costs should be obtained from the relocator.

Other Transferring Organization costs are presented (closing, tax gross-up, moving services, temp living) based on calculations from the inputs on those costs already entered. Certain inputs may be ignored by professional 10 by overriding those costs to zero and not including those costs in the analysis. A one-time implementation fee may be added as a dollar amount and thusly added to the calculated total. Program total costs per home and ‘extended’ (cost per home x number of homes) are calculated for each tier, and summed within each option. These figures may be compared tier-by-tier to the Transferring Organization's historical same-tier costs, industry averages, or specific averages or quotes from relocation agents.

Mortgage closing and tax gross-up costs are two relevant costs for the purchase of the relocator's new house at the new location: 1) closing costs including Transferring Organization-allowable “points”, 2) tax gross-up on taxable portion of those closing costs. Who pays for which costs (and whether the cost even exists in the case of tax gross-up) is a function of what product (AVX/BVO, etc) or Program is selected and the nominal mortgage type. As a further complication, experience has shown that even with mandatory funding from the relocation agent, the relocator will often select a commercial mortgage provider. When the relocator does not select relocation agent's financing when those are the nominal required/optional mortgage types, the Transferring Organization may incur expenses that might have not existed, been lower, or been borne by the relocation agent.

In direct home reimbursement programs, the associated reimbursement amount is used to override the total Direct Home Sales Costs, in dollars (DHSC$). With direct relocator LUMP SUM reimbursement Programs, other costs may or may not be relevant depending on whether the Transferring Agent is paying a lump sum to the relocator in concert with an AVO/BVO or Direct Reimbursement program. In the rare event that the Transferring Agent is paying both a relocator lump sum AND a fixed dollar amount per house fee, the sum of those two amounts (grossed-up Lump Sum+Fixed Fee/Home) is used.

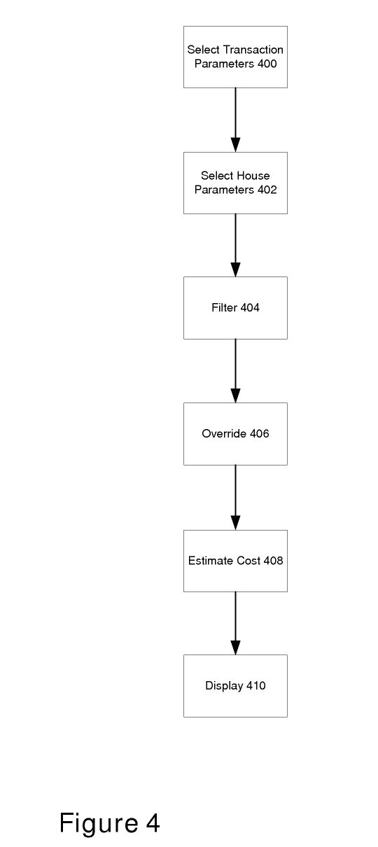

The methodology of the actual calculation of relocation costs is depicted in FIG. 4. Starting with the database of relevant relocation costs as described above, professional 10 selects the appropriate time frame, geographic locations, Program and other transaction parameters in step 400, and the house parameters, in step 402, upon which to base the cost calculation. The data records are filtered based on those transaction parameters in step 404, to provide caluculation values to apply to the house parameters to estimate the relocation costs. Professional 10 may then override any of the values in step 406, and the house parameters may then be used in conjunction with the calculated values and/or override values to determine the estimated cost in step 408. Such estimated cost may be prepared in the context of a relocation agent estimate, a transferring organization budgeting process, or providing a quote, preparing a relocation budget, or otherwise attempting to estimate the cost of relocation. Cost calculator 30, after calculating the extimated cost based on the procedures described below, displays results in step 410. Such a display may be over a couputer screen, in a text message, printed to paper or any electronic file, or other suitable output media.

In the filtering step 404, as one example professional 10 may enter the desired beginning and ending dates. Note the underlying conflict of interests in selecting appropriate dates: (1) longer time periods give more statistical validity to the numbers, particularly considering that data is further parsed into smaller groupings, for example, when selecting the appropriate Market Type and Program; (2) longer time periods may mask the impact of significant changes in market direction during the time period selected; (3) lagging (historical) indicators in a situation where one is trying to sell future performance (i.e. past performance is not necessarily indicative of future performance). Several time period filters may be designated for different expense types, particularly if certain expenses are more time sensitive than other time periods.

Another filter is the house value (sale price), where a maximum and minimum values may be specified to reduce or eliminate outlier houses. The $10,000,000 home and the $9,000 piece of property are likely to skew the results: hence the outlier clipping filter.

House parameters include authorization status, prorate date, and sale price range. Transaction parameters inlcude Program and Market Type, which are used to extract average cost data, average days on market, average days in inventory, and home count.

In one exemplary embodiment, Market Types are defined as 9 market segments into one of which each home (and associated data record in the historical database) is assigned. The 9 categories in this exemplary embodiment are HighValue, MediumValue, and LowValue homes, each in an Improving, Stable, or Declining market. This is done by dividing the filtered database into its highest, middle, and lowest 33rd percentiles of average home price and average gain/loss on sale. This is done at the Market Type level, not the individual home level. This allows differentiation between regions. However, segments may be defined in other ways and on more or less dimensions.

The gain/loss data provides an indicator of market trending in a particular location. When a home is acquired by the relocation agent (or the transferring organization for AVO) it is bought at the then-appraised market value. If, on average, it subsequently looses value and sells for less, then the market must be, on average, declining from when the home was acquired. The opposite is true for improving. Hence markets with the best ⅓ of gain/loss average may have the best trend. Alternatively, other analytical methods may be used to quantitatively or qualitatively classify different geographic regions.

For this embodiment, each Market Type a vertical lookup is done against the percentile table returning a value for market value and one for the market trend (in effect creating a 3×3 matrix). Thus, any selected Market Type is really looking not at data from one particular location, but instead all 1/9 of the entire dataset that matches in value-trend description. On average, there may not be sufficient houses for statistical validity in an individual geographical location, however by grouping together locations with similar properties as described above, a better estimator may be calculated.

Industry average costs and parameter values may be provided as the default values in some or all of the expense items. Alternatively, professional 10 may use actual historical values from a particular relocation agent. In fact, the output of expense calculator 30 may be presented as a comparison of one or more relocation agents and the industry averages.

In a further embodiment of the invention, a “factor” may be added to the industry average data. That may easily be done by adding two matrices: the first is identical to the existing matrix. The second matrix provides a factor for each cell in the first matrix. The resulting factored matrix is simply the cell-by-cell product of the two new matrices (not matrix multiplication). As a further extension of this embodiment, a third matrix may be added that adjusted the overall level by adding the predetermined values to each corresponding matrix element or cell.

Much of the complexity of preparing relocation cost estimates has to do with the data override functionality (where values known to professional 10 are used to override industry average or relocation agent average and any related calculations). If override changes are made to the underlying formulae, great care should be taken in copying the formulae to other portions of the data base or cost calculator 30. For example, if the parameter real estate commission (typically a percentage) were changed, the formula may be replicated to the real estate incentive percentage field, other closing cost percentage, but not to total closing cost percentage, which is the sum of the previous three, for example.

The relocation data used in an exemplary embodiment is primarily calculated from the average of filter-selected historical data. This use of filter-selected historical data allows the use of known data rather than hypothetical reasoning, however these benefits must be weighed against other factors, For one, a study of the various cost, time, value etc., data shows those types of data may be extremely non-normal over some time periods. Variations within the data may be very high; standard deviations (a poor determinant of variation for such non-normal data) are typically higher than the average. Causal factors are poorly understood and not generally represented in the data, and uncorrected data entry errors may skew the results. Results at the product level are necessarily mixtures of two very different populations (those house sold amended (by the relocator), those sold real estate have significantly different costs in many instances), which may result in an inherently binomial distribution variability around the amended value rate itself It may be problematic to use historical data to predict future performance, even with well behaved normally distributed, low variation data. Sudden changes in the market dynamics are likely to be missed by an inherently trailing indicator system. Offsetting these problems is the law of large numbers or the central limit theorem, which loosely says that many samples of reasonable size taken from a non-normal population will have their averages normally distributed around the true population average. The standard deviation of those average values decreases as the square root of the sample size.

For risk management or pricing use, in one embodiment the calculations may be improved by use of a Monte Carlo simulation which would generate ranges of output with clearly defined error bands. With a Monte Carlo simulation, in addition to calculating that a particular average cost was $2,381, there is an additional calculation of error bands around that average, perhaps showing the 95% probability profile to be between $1,500 and $4,000. For some situations this results may be less satisfying, but such a calculated range may be better for the cost analyst and risk manager.

The resulting segmented data tables are also useful in performing statistical analysis of the historical data to potentially find new correlations within the data. When new correlations are found, the database creation process may be redefined to include or exclude some of the dimensions that classify data records. Additionally, if new correlations are determined that involve calculated values, then new calculated fields may be created in the database creation process. Such analysis may be accomplished by regression analysis, e.g. R squared analysis.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computer for providing a user a relocation cost calculation system, said computer comprising:
a relocation data file including information on relocation expenses, said relocation data file including calculated information based on historical data relating to house parameters and transaction parameters;
an interface module for receiving the house and transaction parameters on a relocation project from the user, said interface module capable of presenting a total cost of ownership report to the user; and
calculator software for creating the total cost of ownership report based on the house and transaction parameters received from said interface module and said relocation data file.

2. The computer of claim 1 further comprising updater software capable of receiving additional relocation data from an external source and incorporating the additional relocation data into said data file.

3. The computer of claim 1 wherein said calculator software includes a spreadsheet program, and said data file includes a plurality of parameters for use in a spreadsheet of said spreadsheet program.

4. The computer of claim 1 further comprising communications software, said communications software adapted to send the house and transaction parameters to a remote server, said communications software further adapted to receive additional information from the remote server and include the additional information in said relocation data file.

5. The computer of claim 4 further including a filter module adapted to send filtering parameters to the remote server so that the remote server sends a subset of said relocation data file for used by said calculator software.

6. The computer of claim 1 wherein said relocation data file includes market segmentation information regarding the geographical information and related expense information.

7. The computer of claim 1 wherein said relocation data file further includes information regarding the type of relocation program and related expense information.

8. The computer of claim 1 wherein said interface module includes an override module, said override module adapted to accept user input as a replacement for information of said relocation data file and instruct said calculator software to substitute the user input for the specified relocation data file information.

9. A server for providing remote users a relocation cost calculation system, said server comprising:
a relocation database including information on relocation expenses, said relocation data file including calculated information based on historical data relating to house parameters and transaction parameters;
a user interface module capable of sending interaction software to remote users, the interaction module adapted to request entry of house and transaction parameters for transmission to said server, and adapted to present a total cost of ownership report to the remote user;
an interface module for receiving house and transaction parameters on a relocation project from instances of the interaction software, said interface module capable of creating a total cost of ownership report to the remote user via instances of the interaction software; and
calculator software for creating the total cost of ownership report based on the house and transaction parameters received from said interface module and said relocation database.

10. The server of claim 9 further comprising filter software capable of receiving additional parameters from the remote user to create a sub-set of said data file for use by said calculator software.

11. The server of claim 9 wherein said relocation data file includes market segmentation information regarding the geographical information and related expense information.

12. The server of claim 9 wherein said relocation data file further includes information regarding the type of relocation program and related expense information.

13. The server of claim 9 wherein said interface module includes an override module, said override module adapted to accept user input as a replacement for information of said relocation data file and instruct said calculator software to substitute the user input for the specified relocation data file information.

14. A method of creating a relocation expense database comprising the steps of:
obtaining relocation expense data records that include historical expense data;
specifying dimensions of the relocation expense database for segmentation;
classifying the expense data records according to the specified dimensions;
filtering the expense database according to user specified criteria; and
calculating data fields from the filtered expense database according to the specified dimensions among the specified segments.

15. The method of claim 14 wherein said calculating data fields includes calculating average expenses according to the specified dimensions.

16. The method of claim 15 wherein said calculating data fields includes performing a Monte Carlo simulation of the expenses.

17. The method of claim 14 wherein the expense data records include house related information and transaction related information.

18. The method of claim 14 wherein the segments relate to geographical information relating to the house of each expense record.

19. The method of claim 14 wherein the segments relate to transaction types associated with each expense record.

20. A computer readable medium storing a plurality of instructions for enabling operation of a computing device to perform the steps of:
interfacing with a user to receive house and transaction parameters on a relocation project;
calculating a total cost of ownership report based on the house and transaction parameters received from the user and a relocation data file; and
presenting the total cost of ownership report to the user.
